(19) United States
(12) Patent Application Publication
(10) Pub. No.: US 2025/0285230 A1
(43) Pub. Date: Sep. 11, 2025

(54) CONDITIONAL AND MARGINAL MODEL BASED FRAME GENERATION

(71) Applicant: Irreverent Labs, Inc., Dover, DE (US)

(72) Inventors: David Maxwell CHICKERING, Bellevue, WA (US); Patrice Y. SIMARD, Clyde Hill, WA (US)

(21) Appl. No.: 18/599,000

(22) Filed: Mar. 7, 2024

(51) Int. Cl. G06T 5/60; G06T 5/50; G06T 5/70; G06T 11/00

(52) U.S. Cl. CPC G06T 5/60; G06T 5/50; G06T 5/70; G06T 11/00; G06T 2207/10016; G06T 2207/20076; G06T 2207/20081; G06T 2207/20084

(57) ABSTRACT

Embodiments of the present disclosure relate to a combination of a conditional and marginal model, where the conditional model provides its conditional frame prediction as input to the marginal model. Various embodiments leverage an incremental diffusion process to insert the predicted frame by mixing it with noise and starting the diffusion process part way or at some intermediate level. Some embodiments also minimize the propagation of errors introduced in the process of video generation by recursive prediction of video frames.

### BACKGROUND

State-of-the-art (SOTA) video generation networks employ sophisticated deep learning architectures, often based on recurrent models (e.g., Recurrent Neural Networks) or generative models (e.g., Generative Adversarial Networks), to predict future video frames. These models are designed to learn temporal dependencies between consecutive video frames, capture complex patterns within video frames, and generate realistic and coherent sequences of frames. These networks are typically trained on large datasets of videos and learn to generate new frames that are consistent with the previous frames.

While video generation networks have made some progress, they still lack the ability of generating realistic and high-quality videos. For example, there are often instances where undesired artifacts or other anomalies occur. In an illustrative example, there may be rapid and noticeable changes in brightness or color between consecutive frames, leading to a flickering effect. There may also be temporal jitter, which is sudden, unnatural jumps or shifts in the motion of objects within the video. These and other anomalies lead to poor frame quality and inaccuracy in video frame prediction. Moreover, undesired artifacts and anomalies are not just limited to video generation, but they can arise in any digital media format, such as digital photographs, audio, or the like. For example, with respect to audio, artifacts can include ringing, echo, and hissing. With respect to digital photographs, artifacts can include elastic deformities, misplaced pixels, or pixel saturation.

### BRIEF DESCRIPTION OF THE DRAWINGS

The present disclosure is described in detail below with reference to the attached drawing figures, wherein:

FIG. 1 is a block diagram of an example computing system architecture, according to some embodiments;

FIG. 2 is a block diagram of an example pipeline illustrating the inputs and outputs for generating one or more frames in a recursive manner, according to some embodiments;

FIG. 3 is a schematic diagram of an example pipeline that visually illustrates how video frames are generated in a recursive process, according to some embodiments;

FIG. 4 is a schematic diagram illustrating how a frame is generated by a marginal model by running a diffusion process from an intermediate step using a conditionally generated frame combined with noise as a starting point; according to some embodiments;

FIG. 5 is a flow diagram of an example process for training a conditional model to generate one or more frames, according to some embodiments;

FIG. 6 is a flow diagram of an example process for training a marginal model to generate one or more marginal frames, according to some embodiments;

FIG. 7 is a flow diagram of an example process for using a combination of a conditional model and a marginal model to generate one or more frames, according to some embodiments;

FIG. 8 is a block diagram of an example computing environment, suitable for use in implementing some examples, according to some embodiments; and

FIG. 9 is a block diagram of an example computing device(s), suitable for use in implementing some examples, according to some embodiments.

### DETAILED DESCRIPTION

As described above, existing video generation networks and other existing frame-generation technologies still fall short of generating realistic and high-quality videos or other digital media. There are often instances where undesired artifacts or other anomalies occur. For example, the generated video frames may lack sharpness or exhibit blurriness, particularly in regions with intricate details. In another example, ghosting may occur, which includes duplications or faint remnants of objects in the video, creating a ghosting effect. Object distortions may also occur, such as stretching or squashing. These are unnatural distortions in the shape of objects as they move across frames, leading to unrealistic deformations. There may also be object fragmentation, where objects may appear fragmented or disjointed, especially during rapid movements. There may also be background artifacts, such as changes in the background that do not align with the overall scene, leading to inconsistencies and unrealistic scenarios. Some technologies produce a lot of texture artifacts, which are unnatural patterns or textures in the background that do not match the scene context. There may also be color and contrast issues, such as color bleeding (e.g., spillover of colors between objects or regions where colors should be distinct) and inconsistent contrast levels between adjacent frames, resulting in abrupt changes in visual perception. Additional image quality problems include temporal lag, temporal lead, over-smoothing, over-sharpening, and unrealistic lighting changes.

These anomalies are amplified in recursive generation technologies that perform recursive prediction. In the context of generative ML models, “recursive” prediction refers to a system where a conditional model uses at least one frame (i.e., the model is “conditioned” on input frames) to predict the next frame in a sequence, and then each predicted frame is fed back into the system recursively to inform the prediction of the next new frame. For example, a recursive prediction system might have a conditional model that predicts the next frame given the previous three frames. In an illustrative example, given the frames [1], [2], and [3] as input, the system predicts frame [4]. Next, frames [2], [3], [4] are given to the conditional model to predict frame [5], at which point frames [3], [4], [5] are used at the next step. This procedure continues to produce a sequence of frames of arbitrary length.

This “amplification” of anomalies mentioned above could manifest, for example, if the conditional model predicts that one of the pixels in the next frame is substantially darker than it should be, thereby introducing an anomaly. Because this frame is fed back into the recursive system as an input frame, the model may preserve or even amplify such artifact over time because the model was likely trained to keep adjacent frames consistent or visually similar. Additionally, the model might subsequently predict additional artifacts (e.g., larger blobs of dark pixels) based on the presence of the original artifact in the input frame.

Various embodiments of the present disclosure provide one or more technical solutions that have technical effects in light of these technical problems, as well as other problems, as described herein. Such technical effects include the generation of more accurate frames (e.g., in image processing), high-quality frames, and/or frames with less artifacts or other errors (e.g., image processing errors) relative to the existing technologies (e.g., SOTA video generation networks) described above. Specifically, various embodiments relate to minimizing the propagation of errors (e.g., artifacts) introduced in the process of frame generation by recursive prediction of frames via one or more machine learning models. A “frame” as described herein refers to a single video frame, a digital image (e.g., a digital photograph), a single interlaced field (e.g., a field of a video frame), an audio signal, a sample or file, or other unit/format of digital media.

In some embodiments, the one or more machine learning models include a combination of a conditional model and a marginal model (e.g., a marginal diffusion model) to produce a recursive prediction of frames and handle artifacts or other errors produced by the conditional model. That is, given a next predicted frame from the conditional model, the marginal model produces a new predicted frame that is less likely to contain artifacts or other errors. This new predicted frame is then fed recursively back to the conditional model before the next frame is predicted. This process not only corrects artifacts and prevents them from propagating, but it also improves the predictions (e.g., image quality of the next generated frame) of the conditional model, because it performs better on examples similar to what it has been trained on.

In an illustration, consider the following notation and example-[k] is used to denote the kth conditionally-predicted frame, and [k′] is used to denote the frame that results by “cleaning up” [k] (e.g., removing an artifact) by using the marginal model. Suppose a conditional model takes, as input, 3 given video frames [1], [2], [3] from some source. Various embodiments use the conditional model to predict video [4]. Next, particular embodiments leverage the marginal model to convert [4] to [4′]. This “cleaned up” fourth frame [4′] would then be output as the next frame in the video, and recursively fed back to the conditional model for the next frame prediction. That is, the fifth Frame would be produced by running the conditional model using [2], [3], [4′] as input (instead of [2], [3], and [4]), producing the conditional prediction [5], which would then be converted by the marginal model into [5′]. This process would repeat for as many frames as is required in the video.

In some embodiments, the marginal model represents a diffusion model that is used to correct and prevent artifacts and/or other errors across time for recursive prediction. Diffusion models are a class of probabilistic models that leverage mapping an easy-to-sample distribution (e.g., pixel white noise) to a hard-to-sample target distribution, such as a collections of images or videos from the real world. The noise distribution for frame prediction may be a standard-normal distribution for each pixel and RGBA channel in the predicted Frame. A diffusion model is trained to incrementally convert samples from the noise distribution to samples from the training distribution. In an illustrative example, a diffusion model could be trained to convert standard-normal pixel noise into multiple video frames from a video frame sequence of tennis matches.

Diffusion models may be conditioned in practice by “prompts” that alter the target distribution of the noise-to-image process. For example, a prompt could be or include a previous set of frames, or a natural language description such as “volley,” which would may result in a random frame that contains a tennis player performing a volley.

Diffusion models typically perform a diffusion process by incrementally converting from the noise distribution to the target distribution in a number of steps, where the state of all previous steps is encoded in a representation of the same dimension as the noise and image. Diffusion models may use thousands of steps in such diffusion process. Each step of the diffusion process converts a “noisy” representation of an image (initially, the input is nothing but noise) into a slightly “less noisy” representation in a progressive manner, so that by the last step of the process we have a sample of a pure image.

Various embodiments engage in the diffusion process at some intermediate step or part-way through diffusion (e.g., by denoising the image starting at a particular alpha (a) level). It is possible to insert a frame prediction part-way through the multistep process, as described in more detail below. It is through this “part-way diffusion” method particular embodiments enforce the temporal consistency of frames produced by the marginal model. Given a conditionally predicted frame, particular embodiments choose a diffusion step to insert that frame such that the resulting marginal sample is consistent with the predicted frame from the conditional model but with the added benefit of having artifact(s) removed. For example, using the illustration above, some embodiments leverage an incremental diffusion process by inserting the predicted frame [4] at a particular intermediate diffusion level (e.g., at alpha equals 0.5) and mixing frame [4] with noise and to generate frame [4′].

Various embodiments of the present disclosure are therefore directed to one or more machine learning models (e.g., a neural network), which recursively predicts the next frame of video, given a number of previous frames as input. One objective is to generate realistic accurate video. The ability to eliminate undesired artifacts in a predicted frame is especially useful to the stable generation of long sequences. SOTA video AI models are able to generate fewer than 384 frames. At a frame rate of 24 frames per second (fps), that is sixteen seconds. With recursive and stable next frame generation, various embodiments should be able to generate well over 1000 frames of consistent video. The ability to generate long consistent sequences of video is highly desired and would represent a significant technical breakthrough in the field of video generation from machine learning.

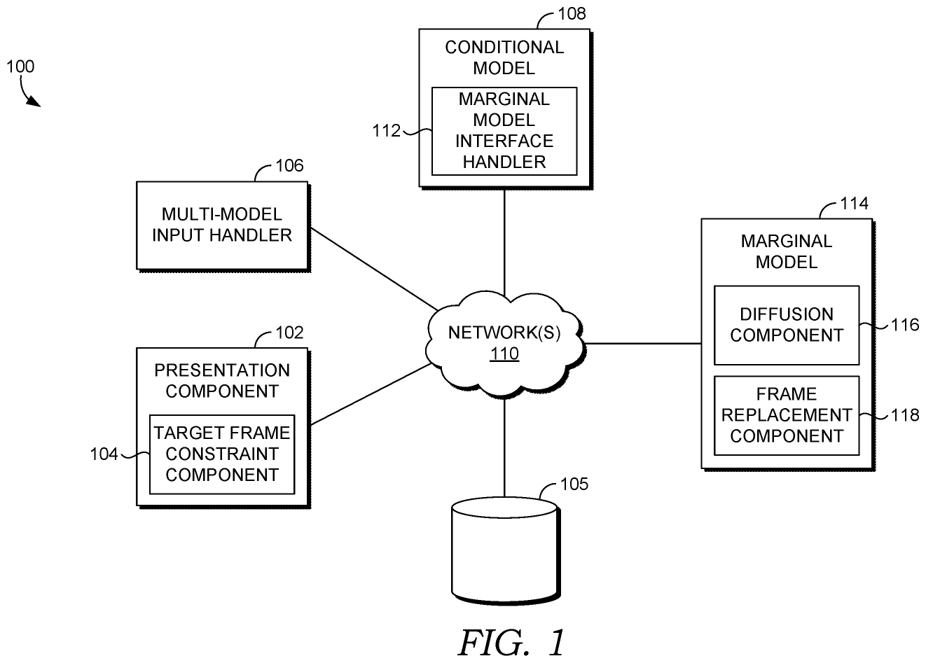

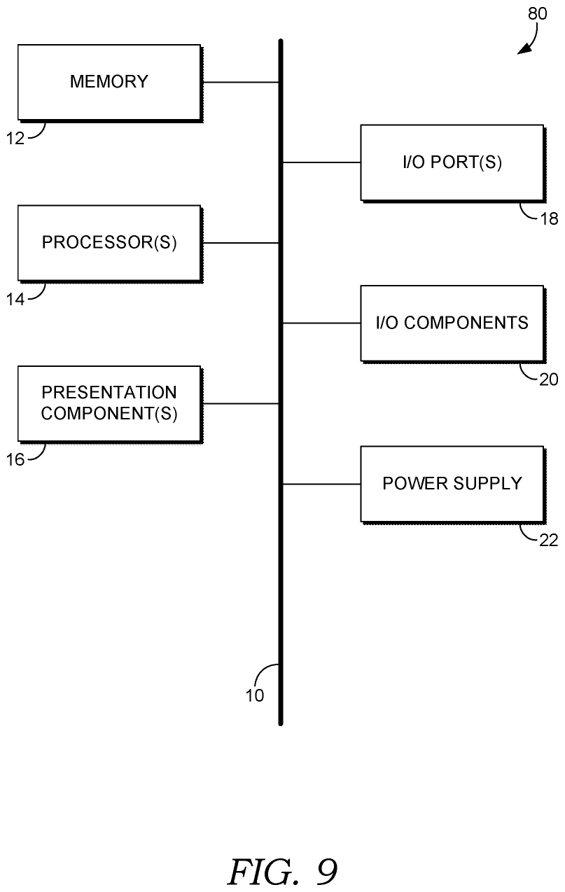

Turning now to the figures, FIG. 1 is a block diagram of an example computing system architecture 100 (referred to herein as “system 100”), according to some embodiments. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. For example, each component of the system 100 may represent executable modules or code to be executed by one or more processors. In some embodiments, the systems, methods, and processes described herein may be executed using similar components, features, and/or functionalities to those of example computing device 80 of FIG. 9.

In the embodiment illustrated in FIG. 1, the system 100 includes a presentation component 102, a multi-model input handler 106, a conditional model 108, a marginal model 114, and storage 105, each of which is communicatively coupled to each other via the one or more networks 110 (e.g., a Wide Area Network (WAN) and/or a Local Area Network (LAN)) and/or through other functionality, such as program calls, return values, or the like.

The presentation component 102 is generally responsible for presenting content (or causing presentation of content) and related information to a user device. For example, the presentation component 102 may cause presentation of a frame output (e.g., transmitting a generated frame to an audio or display device) produced by the conditional model 108 and/or the marginal model 114 and/or any associated functionality. Presentation component 102 may comprise one or more applications or services on a user device, across multiple user devices, or in the cloud. For example, in one embodiment, presentation component 102 manages the presentation of content to a user across multiple user devices associated with that user. Based on content logic, device features, and/or other user data, presentation component 102 may determine on which user device(s) content is presented, as well as the context of the presentation, such as how (or in what format and how much content, which can be dependent on the user device or context) it is presented, when it is presented. In particular, in some embodiments, presentation component 102 applies content logic to device features, or sensed user data to determine aspects of content presentation.

In some embodiments, presentation component 102 generates user interface features. Such features can include interface elements (such as graphics buttons, sliders, menus, audio prompts, alerts, alarms, vibrations, pop-up windows, notification-bar or status-bar items, in-app notifications, or other similar features for interfacing with a user), queries, and prompts. The presentation component 102 can additionally or alternatively cause presentation of other contextual data or metadata, such as timestamps of when a frame was uploaded or the like.

The presentation component 102 includes a target frame constraint component 104. The target frame constraint component 104 is generally responsible for handling and passing one or more user-defined constraints to the multi-modal input handler 106, the conditional model 108 and/or the marginal model 114 to generate one or more target frames. A “target frame” as described herein refers to a particular frame with specific content that a user requests to be generated by the conditional model 108 and/or the marginal model 114. For example, a model may be requested to generate a fight scene between two fighters and at a user interface, a user may input a natural language sequence “within 5 seconds, generate an image frame with a person laying on the ground as a result of being stricken.” The target frame constrained component 104 may then pass this natural language sequence to the multi-modal input handler 106, which may then pass an encoded sequence (e.g., a soft prompt) representing such natural language sequence to the conditional model 108 as input.

The multi-modal input handler 106 is generally responsible for receiving multiple types of inputs and passing a representation (e.g., an encoded vector) of them as input to the conditional model 108 and/or the marginal model 114. In some embodiments, the conditional model 108 and/or the marginal model 114 are thus designed to handle and integrate information from various modalities, such as text (e.g., natural language words as passed from the target frame constraint component 104), images, audio (e.g., sound data, such as punching sounds in a fight scene), video, frames, sensor data, and/or the like.

In some embodiments, after the multi-modal input handler 106 receives one or more modalities, it performs various integration techniques to combine the input with the conditional model 108 and/or the marginal model 114. For example, the multi-modal input handler 106 may combine information from different modalities (e.g., text and image frames) at the input level before feeding it to the conditional model 108 and/or the marginal model (early fusion). Alternatively or additionally, the multi-modal input handler 106 may process information from each modality separately and combine the results at later stages in the conditional model 108 and/or the marginal model 114 (late fusion). In some embodiments, the multi-modal input handler 106 dynamically emphasizes or suppress different modalities based on the context or importance (e.g., via an attention mechanism of a transformer).

The conditional model 108 is a model that is conditioned to generate or predict one or more frames in a recursive manner based at least in part on processing one or more other frames as input. In other words, the conditional model 108 takes, as input, conditioning information such as previously generated frame(s) and/or future frames to influence the generation of frames. In some embodiments, the conditioning information additionally includes natural language textual descriptions from the multi-modal input handler 106 or the target frame constrain component 104, class labels, or other previous frames from the same video sequence.

In some embodiments, the conditional model 108 is represented by a chain of two U-Nets, where the first U-Net represents a deterministic model that predicts/generates one or more frames and the second U-Net takes the prediction/frame produced by the first U-Net as input to engage in diffusion. Deterministic models provide a single, fixed prediction for a given input (e.g., a prediction of what next frame should look like), while probabilistic models offer a distribution of possible outcomes, allowing for a more nuanced representation of uncertainty and variability in the system being modeled.

A U-Net (“U-shaped network”) is a type of convolutional neural network (CNN) architecture that may be used for image segmentation tasks. However, it can also be adapted for various other tasks, including generating frames or images. The U-Net architecture is characterized by a U-shaped structure, where the contracting path captures context and the expansive path enables precise localization.

In some embodiments, the first U-Net takes input data that provides the context for frame generation. This input may include one or more frames, or additional information describing the desired content or conditions (e.g., information from the multi-modal input handler 106). The input data may then pass through a series of convolutional layers, each followed by an activation function (e.g., ReLU) and/or normalization layers (e.g., batch normalization). Downsampling operations such as max-pooling or strided convolutions may then occur, which reduce the spatial resolution while capturing hierarchical features. Then a bottleneck function may occur—the contracting path leads to a bottleneck layer where the most abstract and compressed representation of the input data is obtained. Then an expansion path function or decoder functionality is performed. The expansive path involves upsampling operations (e.g., transposed convolutions) to gradually restore the spatial resolution. Skip connections may then concatenate feature maps from the contracting path at corresponding levels, aiding in the recovery of fine details and preventing information loss. The final layer of the U-Net generates the output frames deterministically based on the processed information. For deterministic frame generation, a linear activation function might be used if predicting pixel values directly. Alternatively, other activation functions appropriate for the specific task could be employed. During training, a deterministic loss function may be employed to measure the discrepancy between the predicted frames and the ground truth frames. For example, loss functions for deterministic frame generation include mean squared error (MSE) or other regression-based loss functions, depending on the nature of the output.

In some embodiments, such deterministic frame generation output by the first U-Net is then passed to a second U-Net, which has identical architecture but that which is represented by a diffusion model to perform a diffusion process. U-Net diffusion model refers to a U-Net architecture that incorporates elements inspired by diffusion models, which are often used for image synthesis tasks, including frame generation. Diffusion models build on the concept of iteratively applying a diffusion process to gradually generate high-quality images.

The second U-Net diffusion model takes as input the predicted generated frames from the first U-Net model. This input provides the initial conditions for the diffusion process. The input frames pass through a series of convolutional layers in the contracting path. Each layer is followed by an activation function (e.g., ReLU) and possibly normalization layers. The encoder captures hierarchical features and reduces the spatial resolution of the input frames. Inspired by diffusion models, the second U-Net may then introduce a diffusion process where information is iteratively spread across the feature maps. This process involves multiple steps or iterations, each representing a diffusion step. The first step is a decoder (or expansive path). The expansive path of the U-Net involves upsampling operations (e.g., transposed convolutions) to recover the spatial resolution. Skip connections concatenate feature maps from the contracting path to aid in the reconstruction of fine details. The final layer generates the output frames at the end of the diffusion process. The activation function used depends on the nature of the output. In some embodiments, it is a linear activation for pixel values or another suitable activation for the specific task.

During each diffusion step, the feature maps may be updated in a way that simulates the spread of information across the network. This can involve convolutional operations, non-linear transformations, or other diffusion mechanisms. To introduce variability and randomness, the second U-Net may inject noise at each diffusion step. This noise contributes to the generation of diverse samples during training. In some embodiments, the diffusion process is often controlled by an annealing schedule, where the amount of noise injected or the diffusion step's intensity changes over time. This schedule allows the model to balance exploration and exploitation during training.

This combined U-Net approach allows for both consistent, controlled generation (from the first deterministic U-Net) and diverse, realistic variations (from the second diffusion model U-Net). This means that the conditional model 108 can adapt to different scenarios where deterministic outputs are necessary, while still being capable of introducing controlled stochasticity for more natural-looking results. This hybrid approach can be particularly useful in applications where a balance between precision and variability is required, offering a flexible solution that caters to different aspects of the generation task.

In some embodiments, the second U-Net diffusion model (or the conditional model 108 in general) performs diffusion only part-way. That is, instead of running diffusion all the way, the conditional model 108 may extract an intermediate prediction (e.g., a particular frame with alpha level of noise) of the conditional model 108 to seed the marginal model 114. In the same way that embodiments can start the diffusion process part way or at an intermediate step, some embodiments can also stop it part way. At each step, the diffusion model has a prediction for the generated frame that can be subsequently fed to the marginal model 114. This embodiment reduces computing latency and computation in the conditional model 108.

In some embodiments, the conditional model 108 represents alternative or additional architecture(s). For example, in some embodiments, the conditional model 108 represents a Conditional Variational Autoencoder (CVAE), a Conditional Generative Adversarial Network (cGAN), a Text-to-Image Generation Model, or future frame Prediction with Conditioning. Using a cGAN, for example, a generator may generate one or more frames, and a discriminator evaluates the generated frames' realism. In a cGAN, both the generator and discriminator may be conditioned on additional information. For frame generation, this conditioning information could be a class label or other relevant features. In video generation, a conditional model might take the past frames of a video sequence as conditioning information to predict the future frames. This helps the model incorporate the temporal context of the video.

The marginal model interface handler 112 (e.g., a signal to engage in a function call) is indicative of a process or function that is invoked, which interrupts the normal flow of execution in the conditional model 108 to execute the code in the called function for returning one or more frames from the marginal model 114. For example, instead of the conditional model 108 recursively generating future frames based on past frames and recursively using newly generated frames as iterative inputs, in response to the conditional model 108 making its first set of predictions by generating a first set of one or more frames, the marginal model interface handler 112 may programmatically call the marginal model 114 so that the marginal model 114 generates a different version (e.g., a clean version with few artifacts) of the frame(s) passed by the marginal model interface handler 112. In this way, frames produced by the marginal model 114 get used as a recursive input back into the conditional model 108, instead of original frames generated by the conditional model 108. For example, using the illustration above, the conditional model 108 may predict video [4] based on ingesting original input frames [1], [2], and [3]. But instead of the conditional model 108 making another recursive prediction, it calls, via the marginal model interface handler 112, the marginal model 114 to convert [4] to [4′]. This “cleaned up” fourth frame [4′] would then be output as the next frame in the video, and recursively fed back to the conditional model 108 for the next frame prediction. Accordingly, the fifth Frame would be produced by running the conditional model 108 using [2], [3], [4′] as input (instead of [2], [3], and [4]), producing the conditional prediction [5], which would then be converted by the marginal model 114 into [5′].

The marginal model 114 is generally responsible for ingesting one or more generated/predicted frames from the conditional model 108 and/or noise as input and generating different version(s) (e.g., cleaned up versions with no artifacts) of the same frame(s) predicted by the conditional model 108. In other words, for example, the frame(s) generated by the marginal model 114 may include substantially the same media content (e.g., a picture of a dog), but with one or more frame elements (e.g., pixels) that are different due to curing, for example, ghosting, flickering, or jitter in the frame(s) produced by the conditional model 108. In some embodiments, the marginal model 114 is trained unconditionally on no-artifact training examples. As a result, any frames produced by conditional model 108 that contain artifacts will be deemed “less likely” by the marginal model 114 than ones without artifacts. The marginal model 114 thus uses the recursive predictions from the conditional model 108 as input. The marginal model 114 is used to correct frames and make them more consistent with frames observed in a training set. These corrected frames are then fed back into the conditional model 108 to make recursive predictions. This process not only corrects artifacts and prevents them from propagating, but it also improves the predictions of the conditional model 108, because it performs better on examples similar to what it has been trained on.

A “marginal” model refers to a property that predictions/samples generated by the marginal model are not conditioned directly on the previous frames—the term is used in the context of probability theory when referring to the marginal probability distribution for a variable (i.e., a frame output) where any dependence on other variables has been integrated out. This is in contrast to a conditional model, such as conditional model 108, which would represent the conditional probability that the next frame looks like the previous Frames. As an example, a one-frame marginal model could be trained to make single-frame predictions based on training frames from videos of tennis matches. We would expect single-frame samples to produce frames of individuals playing tennis, with the proportion of generated Frames matching the training distribution. Thus, if 5% of the training frames showed players serving, we would expect 5% of the marginally-predicted Frames to be of players serving. Similarly, if half the training Frames were of men's matches, we would expect half the predicted Frames to be of two men playing tennis. Consecutive predictions from a marginal model are not (necessarily) consistent with each other in any temporal sense. Marginal models can be used to predict multiple (temporally consistent) frames. In the tennis-match example, various embodiments may train a marginal model to predict five consecutive frames instead of just one. This model does not (necessarily) use any previous Frames as input, so the output of this model should produce five-frame predictions that match the distribution of arbitrary five-frame sequences in the training data.

In some embodiments, the marginal model 114 represents a diffusion model that performs a diffusion process via the diffusion component 116. A diffusion model is a type of generative model that can be used to generate one or more frames. It is based on the idea of diffusing noise through an image or frame to create a new image or video frame. The process of diffusion involves adding noise to an image or video frame, and then gradually removing the noise over time. This results in a sequence of images or frames that are temporally coherent and have a high degree of visual fidelity. A diffusion model is a type of generative model that can be used to generate video frames. It is based on the idea of diffusing noise through an image or video frame to create a new image or video frame. The process of diffusion involves adding noise to an image or video frame, and then gradually removing the noise over time. This results in a sequence of images or video frames that are temporally coherent and have a high degree of visual fidelity.

In some embodiments, the marginal model 114 represents any suitable diffusion model. Stable diffusion, for example, is a type of generative model that can be used to generate frames. It is based on the idea of diffusing noise through an image or video frame to create a new image or frame. Other examples include a Flexible Diffusion Model, a Residual Video Diffusion technique, or a video Diffusion Model. These models work by generating a subset of video frames to fill in between the missing frames, resulting in high-quality and smooth videos with little to no latency.

In some embodiments, the diffusion component 116 engages in a diffusion process (e.g., at an intermediate step) based at least in part on providing noise (e.g., and in some embodiments during runtime, the generated frame(s) from the conditional model 108) as input. One property of diffusion models is that they incrementally convert from the noise distribution to the target distribution in a number of steps, where the state of all previous steps is encoded in a representation of the same dimension as the noise and image. For example, diffusion models may use thousands of steps. Each step of the diffusion process, the diffusion component 116 can converts a “noisy” representation of an image (initially, nothing but noise) into a slightly “less noisy” representation, so that by the last step of the process there is generated sample of a pure image/frame. In some embodiments, “noise” is defined as one or more random signals that is added to one or more portions of a frame (e.g., each pixel of a video frame) to create a noisy version of the original frame. In some instances, the noise can be modeled as a Gaussian distribution, which is a probability distribution that may be used to model random variables. The amount of noise added to the image can be controlled by adjusting the variance of the Gaussian distribution.

The process training a diffusion model involves adding noise to an image and then gradually removing the noise over time to create a new image. The model learns how to remove the noise by training on a dataset of noisy images and their corresponding clean versions. Once the model has learned how to remove the noise, it can be used to generate new images by starting with complete noise. Alternatively, the diffusion process can generate images that are close to a seed image by adding noise to that seed image and then applying the denoising process from an intermediate point.” ‘alpha’ determines how much noise we add to the seed image, where alpha=0 corresponds to complete noise, and alpha=1 corresponds to no noise. More specifically, the way some embodiments ‘add noise’ is to define: Mix=alpha*seed_image+(1−alpha)*noise.

In a diffusion model, alpha is a parameter that controls the amount of noise added to a frame at each step of the diffusion process. The noise may be modeled as a Gaussian distribution, and increasing alpha decreases noise. During diffusion when going from noisy to less noisy, some embodiments start at some alpha (which is 0 in the case when starting from scratch), and embodiments gradually increase it to produce a de-noised image when we get to alpha=1. During training, do not have a ‘schedule’ for the values of alpha—these embodiments typically sample the values randomly in the range [0,1]. So the learning algorithm gets to see examples of: Mix=alpha*image+(1−alpha)*noise. The ML algorithm learns to predict what the image is as a function of Mix and alpha. In some embodiments, such ML algorithm is trained to predict (image−noise) from (Mix, alpha). Predicting the difference may be “more stable” for the Neural Network.

In general, a smaller alpha value may result in less noise being added to the image, which can lead to lower-quality images. On the other hand, a larger alpha value may result in more noise being added to the image, which can lead to higher-quality images but may also make the training process more difficult. If alpha is too small, the marginal model gets an extremely noisy version of the conditional prediction, and this leads to final predictions that may look very different from the conditional prediction. In the limit where alpha=0, the marginal model is starting from complete noise, and its final prediction is just a random image completely unconstrained by the prediction from the conditional model. If alpha is too big, the marginal model may not be able to remove artifacts-so if, for example, there is a wrongly predicted pixel somewhere and alpha is close to 1, the diffusion process might not interpret the pixel as noise but rather is true signal. In the limit when alpha=1, the marginal model does not do anything at all and just returns its input. In some embodiments, an alpha value somewhere roughly in the range 0.5-0.7 maintains high fidelity in some domains of keeping the prediction consistent with the conditional prediction.

In some embodiments, the marginal model 114 inserts an image prediction (e.g., the one or more frames generated by the conditional model 108) part-way through the multistep process (i.e., it is added at some intermediate step). In a common implementation of a diffusion model, each state in the process represents the linear mixture of a pure noise frame and a pure image frame:

State=alpha*image+(1−alpha)*noise

The first step of diffusion typically has alpha=0, and the process increases to alpha=1 according to a schedule. More generally, the state can be a different function of (1) the image/frame, (2) the noise, and (3) the alpha level. It can be assumed that alpha is monotonically increasing in the step number of the diffusion process. This assumption requires that for alpha=0 the blending function blend (image, noise, alpha)=noise, and for alpha=1, blend (image, noise, alpha)=image. Accordingly, given an image (e.g., or frame generated by the conditional model 108), the diffusion component 116 may start the diffusion process part way through by applying the above mixture formula and running the diffusion process forward from that point. If some embodiments insert with alpha close to zero, the process will mostly ignore the provided frame, whereas if the frame is inserted with alpha close to one, the process will end with a frame that is close to the frame that was initially provided (e.g., an image produced by the conditional model 108).

It is through this “part-way diffusion” method that the diffusion component 116 enforces the temporal consistency of frames produced by the marginal model 114. Therefore, given a conditionally predicted frame from the conditional model 108, we choose a diffusion step to insert that image such that the resulting marginal sample is consistent with the predicted Frame but has artifacts removed.

The marginal model 114 further includes a frame replacement component 118. The frame replacement component 118 is generally responsible for replacing each conditionally generated frame of the conditional model 108 in the recursive process by a different (e.g., cleaned up) version of that same frame. Accordingly, in response to the marginal model 114 generating a different version of the frame(s) received from the conditional model 108, the marginal model passes such modified frame(s) back to the conditional model 108 for further recursive predictions, which thereby effectively replaces the original version of the frame(s) produced by the conditional model 108.

Storage 105 generally stores information including data, frames, computer instructions (e.g., software program instructions, routines, or services), and/or models used in embodiments of the technologies described herein. In some embodiments, storage 105 comprises or represents a data store (e.g., a database), non-volatile storage, volatile storage, or a storage system (e.g., Storage Area Network (SAN) or RAID). Storage 105 may store a stream of sequence and/or labelled training data. Storage 105 may also include pattern inference logic. Briefly, pattern inference logic may include machine learning, statistical, and/or artificial intelligence logic that is enabled to detect, infer, or otherwise recognize patterns and or features within data. For instance, pattern inference may infer explicit, latent, or hidden pattern recognition features or patterns within the training data.

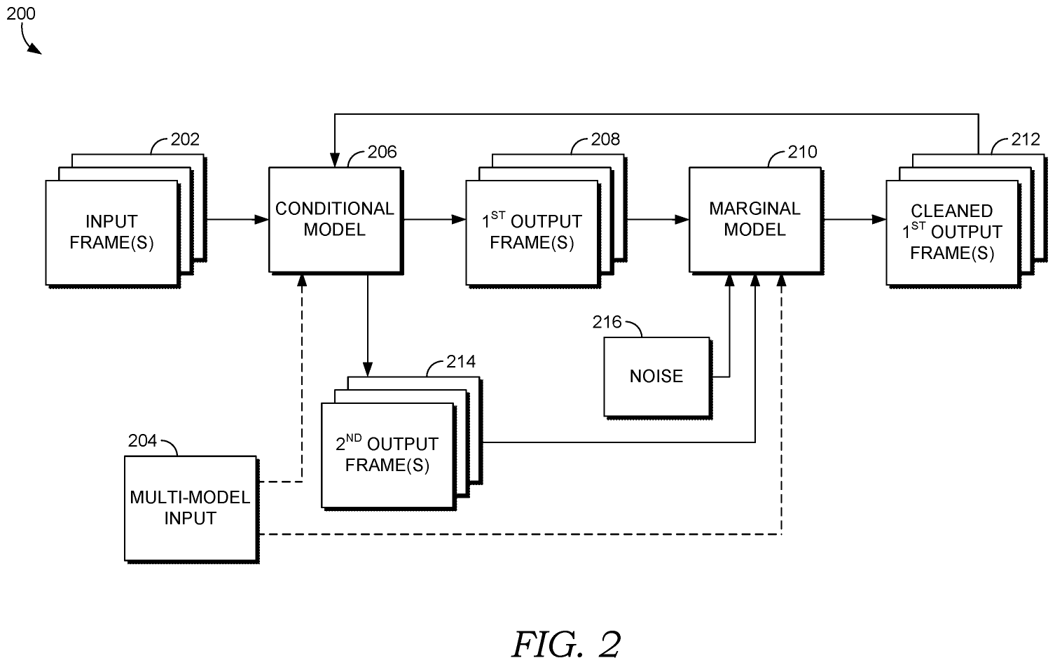

FIG. 2 is a block diagram of an example pipeline 200 illustrating the inputs and outputs for generating one or more frames in a recursive manner, according to some embodiments. In some embodiments, the conditional model 206 represents the conditional model 108 of FIG. 1. In some embodiments, the marginal model represents the marginal model 114 of FIG. 1. In some embodiments, the multi-modal input 204 represents the input handled by the multi-modal input handler 106 of FIG. 1.

At a first time, a first set of input frame(s) 202 are provided as input into the conditional model 206. For example, the first set of input frame(s) 202 may be a temporal sequence of 2 video frames of a football player beginning to throw a football. In another example, the first set of input frames 202 may additionally or alternatively include a target final frame specified by a user (e.g., as produced via the target frame constraint component 104 of FIG. 1), such as natural language text indicating that the last frame generated by the conditional model 206 should be a frame where a receiver catches the football.

In response to the conditional model 206 processing the input frame(s) 202 and/or the multi-modal input, the conditional model 206 generates the first set of output frame(s) 208. According to various embodiments, the multi-modal input 204 can include any suitable modality or set of modalities, such as natural language text (e.g., “make a video of a person throwing a football”), audio (e.g., a sound of a football thrown or crowd noise), and/or the like. In an illustrative example, the first output frame(s) 308 may be indicative of a deterministic prediction of what the pixel values will be in the first output frame(s) 208, how pixels will change orientation from the input frame(s) 202 to the first output frame(s) 208, and/or how edges or other objects that the pixels represent will change orientation from the input frame(s) 202 to the first output frame(s) 208.

In an illustrative example of how the conditional model 206 generates the first output frame(s) 208, the input frame(s) 202 first converted into a matrix. In the case of grayscale images, this may be a 2D matrix, and for color images (with three color channels-red, green, and blue), this may be a 3D matrix (height×width×channels). The matrix may then be passed through an initial layer for feature extraction, which encodes spatial information. This can involve a series of convolutional layers to capture spatial features in each frame. In some embodiments, temporal dependencies are modeled using recurrent layers, such as RNNs or LSTMs. These layers maintain hidden states that capture information from previous frames (i.e., the input frame(s) 202), allowing the model to learn sequential patterns. The final hidden state or the output of the recurrent layer is used to predict the next video frame(s) (i.e., the first output frame(s) 208). This can involve additional layers, such as fully connected layers or convolutional layers, to transform the hidden state into pixel values for the predicted frame. In some embodiments, such as during training, the predicted frame(s) is compared to the ground truth (actual) frame using a loss function. Common loss functions include mean squared error (MSE) or other regression-based losses. The model is trained to minimize this loss during the training process. For example, using the illustration above, the first output frame(s) 208 may be the next 2 video frames illustrating the same football player completing the throw (that are generated in response to processing the first 2 video frames of the football player beginning to throw the football). Accordingly, in some embodiments, the first output frame(s) 208 may represent a temporal sequence or continuation (e.g., a next set of frames) of the input frame(s) 202 that, when consolidated, create a video sequence.

In response to the first output frame(s) 208 being generated, the conditional model 206 passes the first output frame(s) 208 to the marginal model 210. Taking the noise 216 as input, and/or receiving the first output frame(s) 208 according to some schedule (e.g., at an intermediate step during diffusion, as described above), the marginal model 212 responsively generates a cleaned version (e.g., there are no artifacts) of the first output frame(s) 212. In some embodiments, “cleaning” frames can include one or more approaches, such as diffusion (as described herein) so as to iteratively denoise or remove artifacts, filtering, and/or image inpainting. A median filter, for example is effective in removing salt-and-pepper noise, a type of artifact that appears as isolated white and black pixels. The filter replaces each pixel value with the median value in its neighborhood. In another example, Gaussian smoothing is often used to reduce high-frequency noise in images. It works by convolving the image with a Gaussian kernel. Non-Local Means (NLM) is a denoising algorithm that compares each pixel to the surrounding pixels and replaces the pixel value with a weighted average based on similarity measures. Total Variation (TV) denoising minimizes the total variation of pixel intensities in an image, effectively reducing noise while preserving edges. Inpainting algorithms fill in missing or corrupted parts of an image using information from surrounding patches. Any combination of these techniques can be used to clean one or more frames.

Responsive to the marginal model 210 generating the cleaned first output frame(s) 212, the marginal model 210 then passes the cleaned first output frame(s) 212 back to the conditional model 206 so that the conditional model generates the next set of recursive frames—i.e., the second output frame(s) 214). In this way, the input frame(s) 202, the cleaned first output frame(s) 212, and the second output frame(s) 214 get presented, at a user device, instead of the first output frame(s) 208. For example, using the illustration above, the second output frame(s) 214 may represent a set of video frames that represent a temporal next-in-line predicted framed after the cleaned first output frame(s) 212. For example, using the illustration above, the first output frame(s) 208 may be the next 2 video frames illustrating the same football player completing the throw. And the second output frame(s) 214 may represent a receiver catching the football from the football player that was depicted in the input frame(s) 202 and the cleaned first output frame(s) 212 as throwing the football. Accordingly, for example, the input frame(s) 202, the cleaned first output frame(s) 212, and the second output frame(s) 214 may represent a temporal video sequence of a football player throwing a ball to a receiver.

The pipeline 200 loops so that conditional model 206 iteratively generates new predicted frame(s) based on the cleaned output frame(s) produced by the marginal model 210. As illustrated in FIG. 2, for example, the second output frame(s) 214 are responsively passed back to the marginal model 210 so that the marginal model 210 generates another set of second output frames (not shown), which are then fed back to the conditional model 206 to produce another third set of output frame(s) (not shown), and the process continues indefinitely until a condition is met, such as the ending of a video or other specified target frame.

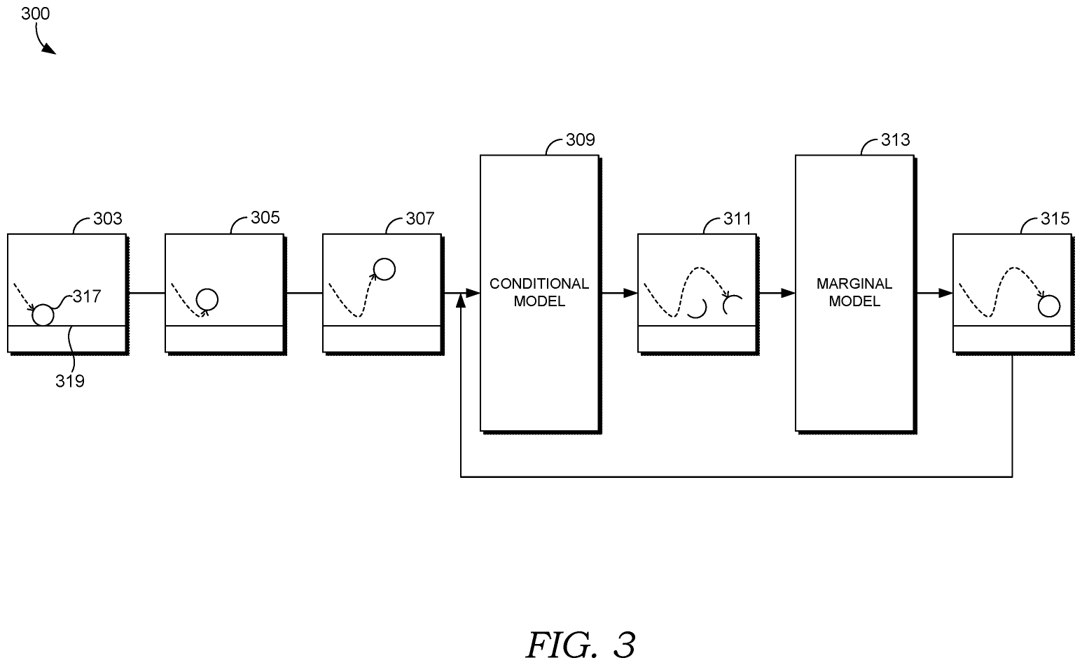

FIG. 3 is a schematic diagram of an example pipeline 300 that visually illustrates how video frames are generated in a recursive process, according to some embodiments. In some embodiments, the conditional model 309 represents the conditional model 206 of FIG. 2 and/or the conditional model 108 of FIG. 1. In some embodiments, the marginal model 313 represents the marginal model 210 of FIG. 2 and/or the marginal model 114 of FIG. 1.

At a first time, the video sequence of video frames 303, 305, and 307 is fed to the conditional model 309. That is each individual video frames 303, 305, and 307 are received as input into the conditional model 309. In some embodiments, the video frames 303, 305, and 307 represent the input frame(s) 202 of FIG. 2. As illustrated in FIG. 3, each of the video frames 303, 305, and 307 represents a temporal successive timestamp of pixels representing the ball 317 bounding off the ground 319. Video frame 303 represents the ball 317 falling down and hitting the ground 319. Video frame 305 represents a next-in-line frame (after video frame 303) representing the ball 317 now bouncing upward. Video frame 307 represents a next-in-line frame (after video frame 305) representing the ball 317 bounding further upward relative to the video frame 305. In some embodiments, the video frames 303, 305, and 307 represent a stream of video frames stored sequentially as a video file. There are various video file formats that facilitate this storage. Each format has its own specifications and methods for compressing, encoding, and arranging frames. The encoding process involves compressing and converting raw pixel data into a digital format that can be efficiently stored and decoded during playback.

The conditional model 309 is configured to predict how the ball 317 will appear in relation to the ground 319 by predicting/generating the output video frame 311 (a distorted video frame with artifacts) based on the temporal relationship of the ball 317 in relation to the ground 319 in the successive video frames 303, 305, and 307. In other words, the conditional model 309 learns patterns in (and between) the video frames 303, 305, and 307, such as pixel displacement of the ball 317, in order to, for example, predict where the ball 317 will be in the output image 311. For example, consider a sequence of past video frames 303, 305, and 307. Each frame is represented as a 2D matrix where each pixel corresponds to a specific location. Various embodiments encode the temporal information by stacking or concatenating the past frames along an additional dimension. This creates a 3D or 4D tensor, where the extra dimension represents time. Some embodiments use convolutional layers to capture spatial features within each frame 303, 305, and 307 of the sequence. This helps the model recognize patterns, edges, and object-related information in individual frames. Some embodiments then apply recurrent layers (e.g., LSTMs or GRUs) to capture temporal dependencies across the video frames 303, 305, and 307. These layers maintain hidden states that store information about the context from past frames. Regarding the pixel-wise prediction at 311, the output layer of the conditional model 309 may then predict pixel values for the next frame 311. This can be achieved, for example, through convolutional layers with appropriate activation functions (e.g., sigmoid for binary values, or linear for continuous values).

The marginal model 313 then takes, as input, noise, blends the noise with the distorted video frame 311 in order to predict/generate a cleaned up version of the video frame 311 by producing the output image 315. The output image 315 represents the ball 317 falling back down towards the ground 319, which is the prediction of what the positioning will be of the ball 317 after the video frame 307. As illustrated in FIG. 3, the output video frame 315 is then recursively fed back into the video sequence so that the conditional model 309 takes, as input, the output image 315 to generate yet another distorted output video frame based on patterns or associates learned between the video frames 303, 305, 307, and 315. Accordingly, instead of recursively feeding the distorted output image 311 back into the video sequence to the conditional model 309, the output image 315 is recursively fed to the conditional model 309.

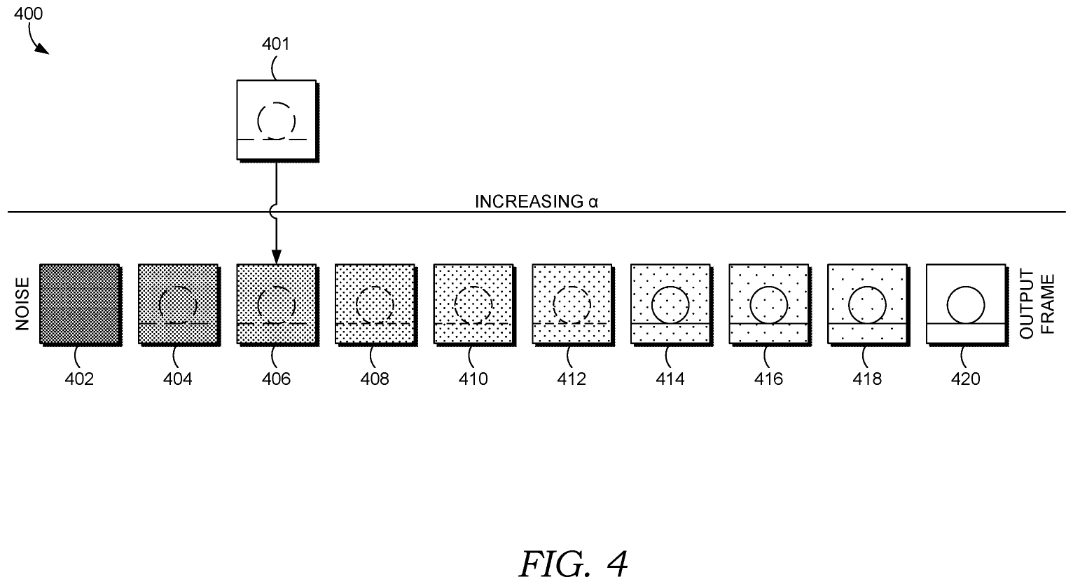

FIG. 4 is a schematic diagram illustrating how a frame 420 is generated by a marginal model by running a diffusion process 400 from an intermediate step (e.g., a particular alpha value) using a conditionally generated frame 401 combined with noise 402 as a starting point. In some embodiments, the frame 401 represents the first output frame(s) 208 of FIG. 2 and/or the distorted frame 311 of FIG. 3. In some embodiments, the output frame 420 represents the cleaned output frame(s) 212 of FIG. 2 and/or the output frame 315 of FIG. 3. In some embodiments, the diffusion process 400 is what is performed by the diffusion component 116 to generate a cleaned output frame(s).

The diffusion process 400 begins with pure noise 402 and increases in alpha (α), which iteratively denoises a density distribution from 402 to 420, each of which represents an iterative step in the diffusion process 400. In other words, denoising occurs from left to right—402, 404, 406, 408, 410, 412, 414, 416, 418, and 420. As illustrated in FIG. 4. The distorted input frame 401 is input at an intermediate diffusion/denoising/noise step corresponding to distribution 406 and a particular alpha (α) value.

An alpha value of zero typically corresponds to the pure noise 402 and an alpha value of 1 typically corresponds to the final output frame 420. By starting diffusion part way or inserting the frame 401 at an intermediate step (e.g., at an alpha value between 0.4 and 0.6), this provides the marginal model with a state. In other words, the marginal model receives an indication of what the frame 401 looks like but the marginal model is not fully committed to the frame 401 because by inserting the frame 401 part-way through diffusion, the rest of diffusion and denoising still needs to occur to clean the frame 401 (i.e., steps corresponding to distributions 406 through 420). This would be in contrast to, for example, if the frame 401 was inserted further down the diffusion process 400, such as at a point corresponding to the distribution 418. In this example, because the diffusion process 400 would almost be complete at this point, there would likely not be as much artifact removal since fewer iterations of denoising would occur. One reason why the frame 401 is inserted at a part-way alpha value is so that all gross positioning (e.g., of edges or objects indicated by pixel values) of objects (e.g., the ball and the ground) is retained. There is a chance, for example, that if the frame 401 was instead inserted in the diffusion process 400 at alpha equals zero or close to zero, particular objects would be unnaturally positioned from one frame to another, which happens in existing technologies.

In other words, inserting the frame 401 at an intermediate step in the diffusion process 400 provides the marginal model with enough flexibility to get rid of any particular artifacts or other errors that are introduced in the frame 401. Therefore, an optimization goal is to provide the marginal model at an alpha level/step where the artifacts appear as noise. When the marginal model processes the frame 401 to make it look plausible (i.e., generate frame 420), it will be able to detect the artifacts and get rid of them (e.g., remove ghosting or add in pixel values to make a circular ball) via denoising. But the marginal model will make the frame 420 appear as close as possible as the frame 401. The method of choosing the particular intermediate step or alpha value between 0 and 1 may be done through any suitable manner. For example, in some embodiments, the alpha value (e.g., 0.5) that the marginal model processes or denoises the frame 401 at is predetermined for every frame processed. In other embodiments, the alpha value is automatically determined on the fly or at runtime based on, for example, using clustering or distance algorithms (e.g., K-Means clustering and Euclidian distance) to match the frame 401 with its closest training data counterpart distribution, which is then mapped to a particular alpha value.

In some embodiments, the diffusion process 400 includes any suitable algorithms and functionality. For example, in the context of diffusion models, blending, adding noise, denoising, and deblending may work together to generate high-quality frames (e.g., the frame 420) from random seeds. In the context of diffusion models for image generation, a “seed” can represent the initial state of the frame (e.g., 406 or 402) and/or the initial values assigned to pixels. The diffusion process then evolves these initial conditions over time, iteratively updating pixel values based on certain rules or algorithms. The diffusion process 400, for example, may start with a noise frame 402, which is gradually refined to become a realistic frame 420. The process of adding noise to the frame is indicative of diffusion, and the process of removing noise from the frame is indicative of denoising. Blending is the process of linearly interpolating between two random seeds to create a new seed, and deblending is the process of separating the two original seeds from the blended seed. By iteratively blending and deblending samples, a mapping between two densities or distributions (e.g., 406 and 408) can be obtained. This mapping can then be evaluated with a neural network trained to deblend samples. The result is a model that behaves like deterministic denoising diffusion, which iteratively maps samples from one density/distribution (e.g., Gaussian noise, as in 402) to another (e.g., the output frame 420). In some embodiments, the specific algorithms for blending, deblending, adding noise, and denoising is done as described in the paper, “Iterative a-(de) Blending: a Minimalist Deterministic Diffusion Model,” which is herein incorporated by reference in its entirety.

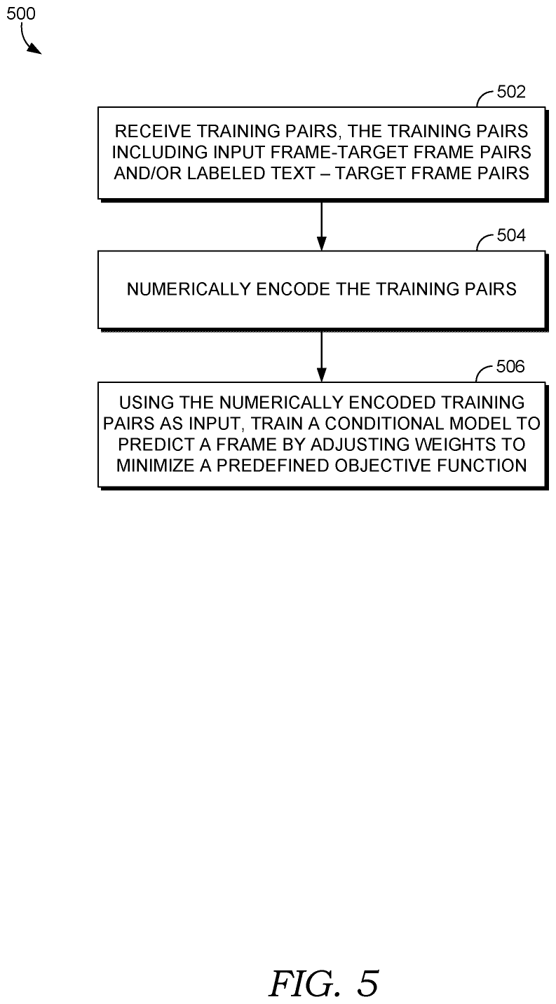

FIG. 5 is a flow diagram of an example process 500 for training a conditional model to generate one or more frames, according to some embodiments. In some embodiments, the process 500 is how the conditional model 108 of FIG. 1, 206 of FIG. 2, and/or 309 of FIG. 3 is trained to generate one or more frames. Per block 502, some embodiments first receive training pairs, which include input frame-target frame pairs and/or labeled text-target frame pairs. A “target frame” as described herein refers to a frame that the model is aiming to predict during the training process. The objective is to train the model to generate an output frame that closely matches this target frame when given a sequence of input frames. In other words, the target frame represents the ground truth or the actual frame that the model should ideally generate. An “input frame” refers to a past frame provided to the model as input for the prediction task. These frames serve as the context or history from which the model learns patterns and dependencies. Accordingly, an input frame-target frame pair is indicative of one or more input frames that are coupled with one or more target frames, which indicates that for a given input frame, or set of input frame, the particular target frame, or set of target frame, the input frame(s) belong to.

The term “text” refers to a natural language description of one or more features of a frame. Accordingly, the phrase “labeled text-target frame pairs” refers to one or more target frames that are labeled/annotated with particular natural language text that describes the target frame. For example, an image of a gray cat with green eyes may be labeled with text that reads “portrait of a cat with gray hair and green eyes.” In some embodiments, human annotators (and/or computers) generate the labeled text-target frame pairs. This annotation can be done by experts or crowdsourced workers who understand the context and can create meaningful pairs. In other embodiments, these pairs are generated automatically or heuristically. In some embodiments, such labeled text-target frame pairs represents CLIP pairs before they are embedded, as described in more detail below.

Per block 504, some embodiments then numerically encode the training pairs. For example, particular embodiments convert each pixel of each frame and/or text into a corresponding matrix data structure that contains values representing the respective frame so that the conditional model can process the values. In an illustrative example, some embodiments normalize pixel values to a common scale, such as between 0 and 1 or −1 and 1. This helps in stabilizing the training process and improves convergence. Some embodiments then resize frames to a consistent size. This ensures that all input frames have the same dimensions, which is useful for feeding them into neural networks with fixed input sizes. Some embodiments may then convert color images to grayscale or keep them in RGB format based on the requirements of the task. This choice depends on whether color information is relevant for the specific application. Some embodiments then flatten the 2D matrix representation of an image/frame into a 1D vector. Alternatively, some embodiments use convolutional neural networks (CNNs) that can directly process image matrices without flattening. Some embodiments ensure that the pixel values are represented using a suitable data type, such as float32. If processing video sequences, some embodiments organize frames into sequences, and ensure that the model can effectively handle the temporal aspect.

With respect to encoded the labeled text-target frame pairs, some embodiments generate CLIP embeddings. CLIP (Contrastive Language-Image Pretraining) is a neural network model developed by OpenAI that learns powerful visual and textual representations by training on a large dataset containing images and their corresponding textual descriptions. CLIP embeddings refer to the high-dimensional vectors that represent the input images and texts after being processed by a CLIP model. CLIP employs contrastive learning, where the model is trained to bring similar pairs of images and text closer together in the embedding space while pushing dissimilar pairs farther apart. This allows CLIP to learn a generalized representation that captures the semantic relationships between images and their associated textual descriptions. The CLIP embeddings enable the model to perform various tasks, such as image classification, object detection, and text classification, without the need for task-specific training.

Per block 506, using the numerically encoded training pairs as input, some embodiments train the conditional model to predict/generate one or more frames by adjusting weights to minimize a predefined objective function. For example, using the target frames as ground truth and given a particular input frame and/or text (from the input frame-target frame pairs and/or labeled text-target frame pairs), the conditional model may predict the pixel values and orientation of edges or objects of the one or more frames. The model can then compare its prediction with the actual correct ground truth target frames and adjust its parameters to minimize the error. In this way, the model can learn to generate frames that are similar to the target frames in the training data given a set of input frames and/or text. Specifically, the training objective is for the conditional model to predict the correct output target frame given a particular input frame and/or text. During training, the model minimizes a loss function that measures the difference between predicted frames and the actual target frames in the training pairs. The conditional model's parameters (e.g., weights and biases) may be updated/adjusted through techniques like backpropagation and optimization algorithms (e.g., Adam, SGD) to minimize the loss and improve the model's ability to generate accurate frames. Training can occurs over multiple iterations (epochs) with batches of training pairs that are fed into the conditional model to adjust its parameters gradually.

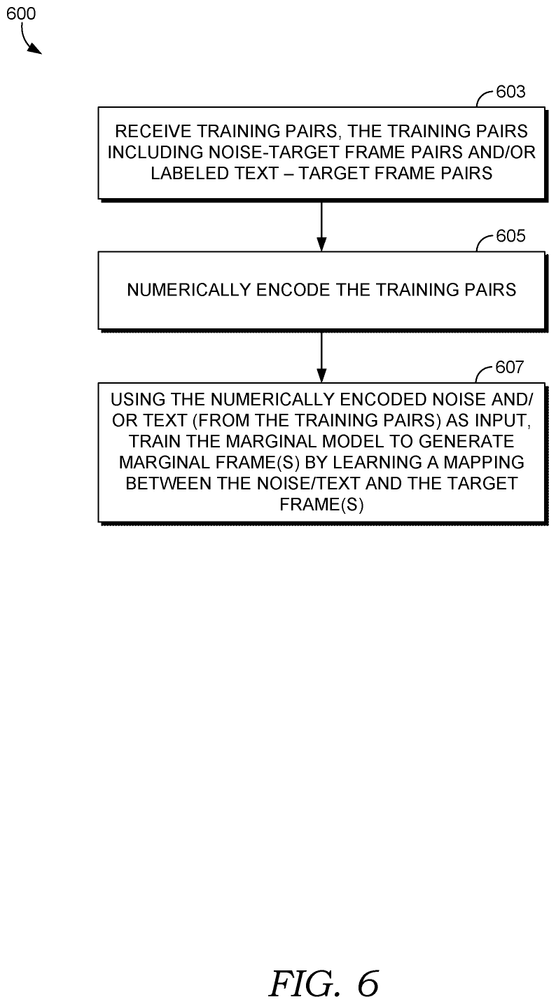

FIG. 6 is a flow diagram of an example process 600 for training a marginal model to generate one or more marginal frames, according to some embodiments. In some embodiments, the process 600 is how the marginal model 1114 of FIG. 1, 210 of FIG. 2, and/or 313 of FIG. 3 is trained to generate one or more frames. Per block 603, some embodiments first receive training pairs, which include noise-target frame pairs and/or labeled text-target frame pairs. The objective is to train the marginal model to generate one or more output marginal frames that closely matches one or more target frames of the noise-target frame pairs when given noise (e.g., at varying degrees or alpha levels). For example, a training data set may include noise at 10 different alpha levels and the target frame each level belongs to.

Per block 605, some embodiments then numerically encode the training pairs. In some embodiments, block 605 includes an identical process relative to block 504 of FIG. 5. Per block 607, using the numerically encoded noise and/or text (from the training pairs) as input, some embodiments train the marginal model to generate one or more marginal frames by learning a mapping between the noise/text and the target frame(s) (of the training pairs). For example, using the target frames as ground truth and given various levels of noise and/or text, the marginal model may iteratively predict different distributions (combinations of noise and a frame) until the model predicts a marginal frame. The model can then compare its prediction with the actual correct ground truth target frames and adjust its parameters (e.g., the weights and biases) to minimize the error (e.g., via a Mean Squared Error (MSE) loss function). In this way, the model can learn to generate marginal frames that are similar to the target frames in the training data given noise and/or text.

Diffusion works by mapping a random distribution (e.g., white pixel noise, alpha=0) to a distribution that corresponds to a plausible frame. If such mapping is learned, then a frame can be mixed with noise, starting from a particular alpha level and then the mapping can be followed across different alpha levels until a marginal frame output is generated. Such mapping can be learned in any suitable manner. For example, some embodiments sample a distribution to get a first example (e.g., a particular combination of noise and a frame, such as 406 of FIG. 4), then the distribution can be sampled again to get a second example (e.g., 408 of FIG. 4). Those two examples can then be blended and the marginal model can be trained to predict the second example from the first example in an iterative fashion along the diffusion process and across different alpha levels until the final marginal frame(s) are predicted at block 607. In an illustrative example, at alpha=0, a number generator can generate a random number for every pixel of a frame to get pure white noise (a first example). Then, particular embodiments can blend the first example with a second example, where the random number generates a random number for fewer than every pixel to get less white noise at an alpha level higher than 0. Then the marginal model may take two different points or pixels (and their values) that have the two different alpha levels such that the marginal model can predict the particular points given the alpha level.

In some embodiments, the frames that are given to the marginal model (e.g., the frames mixed with the noise to create examples) are derived from any suitable training dataset and are inserted at any suitable alpha level of the diffusion process. Such frames represents a conditional model's runtime insertion of a frame to the marginal model, even though the marginal model does not work together with an actual conditional model or actual conditional recursive frames at training. For example, a frame mimicking a conditionally generated frame may be inserted part-way or at an intermediate level of the diffusion process (e.g., alpha=0.5). By inserting such frame part way through the process, embodiments are constraining the marginal model in what it can do to be consistent with the frame it was given.

The training processes 500 and 600 have various advantages over existing technologies. First, the marginal model is trained without knowledge of the conditional model. Because the marginal model is trained marginally, it will “prefer” frame predictions that look similar to the training data (e.g., the training pairs), which presumably do not contain artifacts. Secondly, the marginal model and the conditional model can be trained independently of each other, allowing innovation in each to proceed more efficiently. Third, the conditional model can be trained without needing any special features or noise modeling. Fourth, the marginal model can be used to introduce artifacts and correct them, to generate multiple plausible continuation sequences of frames from the same source. Fifth, different noise models, distortions, and schedules can be used by the marginal model as “priors” to more effectively correct specific kinds of artifacts related to an application. Finally, the proposed system works well in practice, and is able to produce long videos by “fixing up” the predictions from a conditional model that yields artifacts.

In some embodiments, the marginal model is trained to go backwards (e.g., predict a video sequence going from a last video frame in time to a first video frame). For example, if a last frame indicates a person lying on the ground from a fight and the first frame indicated two people walking towards each other before they started fighting, the model may predict, from the last frame of the person laying on the ground to the first frame of two people walking towards each other. Some embodiments can thus start with a corrupted image at X=1. Then, embodiments can blend the corrupted image with noise to go backwards. Today, technologies pick a random noise. Then it is blended with an image and go deterministically in a forward direction. From frame to frame, different noise amounts are selected for going forward. But this can introduce jitter, among other issues. But, as described herein, some embodiments find a starting point part-way through or at an intermediate level of the diffusion process. Accordingly, on a per-frame process, diffusion could be performed backwards (from clean frame to pure noise) and on a per-video process, a video sequence can be predicted from the last frame to the first frame.

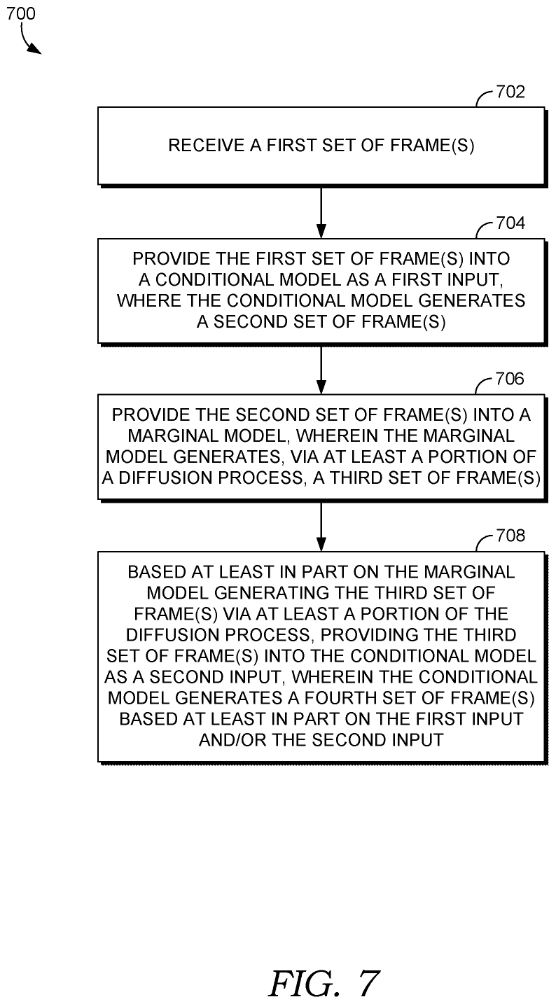

FIG. 7 is a flow diagram of an example process 700 for using a combination of a conditional model and a marginal model to generate one or more frames, according to some embodiments. Therefore, the process 700 illustrates a process by which a conditional model generically provides input to a marginal model with the conditional frame prediction. In some embodiments, the conditional model is first trained via the process 500 before the process 700. Likewise, in some embodiments, the marginal model is first trained via the process 600 of FIG. 6 before the process 700. The process 700 (and/or any of the functionality described herein, such as the processes 500 and 600) may be performed by processing logic that comprises hardware (for example, an AI hardware accelerator circuitry, dedicated logic, programmable logic, microcode, and the like), software (for example, instructions run on a processor to perform hardware simulation), firmware, or a combination thereof. Although particular blocks described in this disclosure are referenced in a particular order at a particular quantity, it is understood that any block may occur substantially parallel with or before or after any other block. Further, more (or fewer) blocks may exist than illustrated. Added blocks may include blocks that embody any functionality described herein (for example, as described with respect to FIGS. 1-6). The computer-implemented method, the system (that includes at least one processor and at least one computer readable storage medium), and/or the computer readable medium as described herein may perform or be caused to perform the process 700 or any other functionality described herein.

Per block 702, some embodiments receive a first set of one or more frames. For example, the first set of one or more frames may represent the input frame(s) 202 of FIG. 2, and/or the input frame(s) 303, 305, and 307 of FIG. 3. In some embodiments, the first, second, third, and fourth set of one or more frame represent one of, one or more digital frames (e.g., a digital photograph), one or more video frames (e.g., a single still image in a sequence of consecutive images that, when played in rapid succession, creates the appearance of motion), one or more single interlaced fields, one or more audio signal, or one or more files (e.g., a sequence of frames, such as a document, image, video, audio recording). A “single interlaced field” corresponds to a method of displaying or transmitting video images in which each frame is split into two fields (each of which is a single interlaced field), and the fields are displayed or transmitted alternately. In an interlaced video signal, the first field contains all the odd-numbered lines of the image, and the second field contains all the even-numbered lines. These two fields are displayed sequentially, creating the illusion of a complete frame. An audio signal is a representation of sound, typically in an electrical or digital form. Accordingly, coupling a “next frame” generation network with an in-line “restorative” network in a recursive setting can be applied to modalities other than video. For example, the next frame in video is analogous to the next unit of time in an audio sequence and would benefit from an in-line restorative capability in a recursive system. Additional or alternative modalities can be used, such as 3D, 4D, audio, motion and speech synthesis.

Per block 704, some embodiments provide (e.g., as at least a portion of a first input), the first set of one or more frames into a conditional model as a first input, where the conditional model generates a second set of one or more frames (e.g., based at least in part on the first input). Examples of block 704 are described with respect to the input frame(s) 202 (e.g., the first set of frame(s)) that are fed to the conditional model 206 to generate the first output frame(s) 208 (e.g., the second set of frame(s)) and/or the frames 303, 305, and 307 (e.g., the first set of frame(s)) that are fed into the conditional model 309 to generate the distorted output frame 311 (e.g., the second set of frame(s)). In some embodiments, block 704 is represented more actively as operations directly performed by the conditional or other model (which is not necessarily a conditional model). For example, block 704 may represent some model (e.g., a RNN or GAN) that may generate the second set of one or more frames based at least in part on the first set of one or more frames or processing the first set of one or more frames.

In some embodiments, the second set of one or more frames represent one or more frames that are predicted to be next in a sequential order after the first set of one or more frames, as illustrated, for example, by the distorted output frame 311 of FIG. 3. For example, if a video included video frames ordered as frames 1, 2, and 3. The frame predicted to be next in the sequential order would be frame 4, which directly follows frame 3 in the sequential order.

In some embodiments, the conditional model is one of a probabilistic diffusion model or a deterministic prediction model trained on mean squared error (MSE). A “conditional model” is a model that predicts (e.g., generates pixel values and line orientations) of one or more next frames given a previous set of already-generated frames. In an illustrative example, given the frames [1], [2], and [3] as input, the conditional predicts frame [4]. The objective is for the conditional model to capture patterns, dependencies, and temporal information in the input frame(s) and use this knowledge to make accurate predictions of the next frame(s). As described above, for example, a video is essentially a sequence of individual frames played in rapid succession. Each frame represents a snapshot of the scene at a specific moment. When these frames are played one after another, the visual content appears to move or change over time. The temporal evolution of frames creates the dynamic experience users perceive as video. Accordingly, the conditional model may be used to generate a particular video frame given a history of prior-generated video frames to create a video.

A “probabilistic” model is a machine-learning model that produces a probability distribution over output values (e.g., frame images) from which random samples can be drawn. This is in contrast to a “deterministic” model whose job is to predict a single “best” output. As an example, a probabilistic model can generate a probability that a conditional next-in-time and its pixel values are X. Whereas a “deterministic prediction model” can, for example, generate a hard class or prediction of a frame without a probability. Probabilistic models are often (but not always) implemented internally as deterministic models that produce, for any fixed input, a single “best” probability distribution-random samples can subsequently be drawn from this distribution. A “probabilistic diffusion model” is a probabilistic model that performs diffusion, as described herein.

In some embodiments, the conditional model generates the first set of one or more frames by running diffusion only part way through a second diffusion process (e.g., diffusion that is performed by the conditional model 108 in addition to the diffusion component 116 of the marginal model 114 performing its own diffusion process). For example, the conditional model 206 may perform diffusion by inserting the input frame(s) 202 into a diffusion process and/or ending/stopping the diffusion process at a particular alpha level (e.g., between 0.2 and 0.7), representing some intermediate level.

In some embodiments, the first input and/or second input at block 704 (and/or the second input at block 708) additionally or alternatively includes a natural language text prompt, an audio signal, or a color request (e.g., as described with respect to the multi-modal input 204 and/or the multi-modal input handler 106 of FIG. 1). In this way, the generating of the third set of frame(s) at block 706 is based at least in part on the natural language text prompt, the audio signal, or the color request. For example, a conditional model may receive a sound of punch connecting with a face, which is then outputted in the second set of frame(s) at a time corresponding with pixel values indicating someone getting punched in the face.

Similarly, some embodiments receive a user prompt that constrains at least one of the conditional model or the marginal model to generate content (e.g., additional frames) until a target final frame is generated. In this way the second set of frame(s), the third set of frame(s), and/or the fourth set of frame(s) includes the target final frame that is generated based at least in part on the user prompt. Example of this is described with respect to the target frame constrain component 104. For example, various embodiments receive a user prompt that states, “Make a video sequence of two people fighting, where both knock each other out at the same time.” Given this input to the conditional model, for example, the second set of frame(s) may be pixel values that illustrate the two people fighting and both knocking each other out.

Per block 706, some embodiments provide the second set of frame(s) as input into a marginal model, where the marginal model generates, via at least a portion of a diffusion process (e.g., diffusion beginning and/or ending at a particular alpha value via the diffusion component 116 of FIG. 1), a third set of one or more frames. As described above, a “marginal model” refers to a property that predictions/samples generated by the marginal model are not conditioned directly on the previous frames, unlike a conditional model. In some embodiments, block 706 represents more of an active operation. For example, block 706 may represent generating, via at least a portion of a diffusion process, a third set of frame(s) based at least in part on the second set of one or more frames.

In some embodiments, the third set of frame(s) represent a different version (e.g., a cleaned up version) of the second set of frame(s). Additionally or alternatively, the third set of frame(s) may represent the second set of frame(s) except that the third set of frame(s) include one or more frame elements (e.g., pixels) that have different values (e.g., pixel values) that one or more frame elements of the second set of frame(s). For example, the third set of frame(s) may represent the output frame 315, which is a cleaned up version of the output frame 311 (e.g., the pixel values corresponding to the edges representing the ball 317 and the ground 319 are correctly aligned, such that the artifacts present in the output frame 311 are not visible in the output frame 315). In other words, although both frames 311 and 315 represent the same content objects (i.e., the ball 317 and ground 319), any of the artifacts described herein (e.g., ghosting) that was present in the output frame 311 may be removed at frame 315 so as to create a cleaned version of the same frame.

In some embodiments, the marginal model generates the third set of frame(s) at block 706 by starting the diffusion process at an intermediate step (e.g., a particular alpha level) based at least in part on providing noise as a portion of the input into the marginal model. Such diffusion process is indicative of preventing artifacts from propagating over time as the fourth set of frame(s) are generated at block 708. Examples of starting the diffusion process at an intermediate step is described in FIG. 4 where, for example, the frame 401 is inserted at a particular alpha level (e.g., the frame 401 is combined with noise at alpha level 0.4). In some embodiments, the third set of frame(s) generated by the marginal model represents a frame with one or more visual artifacts (e.g., object distortions or object fragmentation) that have been removed from the second set of frame(s), as illustrated, for example in frame 315, which represents frame 311, except artifacts have been removed.

Per block 708, based at least in part on the marginal model generating the third set of frame(s) via at least a portion of the diffusion process, some embodiments provide the third set of frame(s) into the conditional model as a second input, where the conditional model generates a fourth set of frame(s) based at least in part on the first input and/or the second input. Block 708 represents the recursive nature of the conditional model, except that instead of the conditional model using its own conditionally predicted frame(s) as input, it takes a different version of the frame(s) from the marginal model as input to generate additional frame(s). In some embodiments, block 708 represents a more active step performed by a model that is not necessarily a conditional or marginal model. For example, based at least in part on the generation of the third set of frame(s), some embodiments generate the fourth set of frame(s). In some embodiments, the fourth set of frame(s) represents at least one frame that is predicted to be next in the sequential order after the third set of frames. For example, referring back to FIG. 3, the output frame(s) 315 may represent the fourth set of frames, which is predicted to be next in the sequential order after frames 303, 305, and 307-a continuation frame of the ball 317 bounding off the ground 319.

In some embodiments, the fourth set of frame(s) are generated based at least in part on using the third set of frame(s) as input instead of the second set of frame(s). Put another way, some embodiments exclude from providing the second set of frame(s) into the conditional model based at least in part on the generating of the third set of frame(s). In other words, in some embodiments, the second set of frame(s) are never provided back to the conditional model. For example, the marginal model interface handler 112, as described in FIG. 1, may be used to interrupt the conditional model's regular process of making next frame predictions based on previous frame predictions by calling the marginal model 114 to generate a clean version of the conditional model's last output.

In other embodiments, however, the second set of frame(s) are provided back to the conditional model as input depending on the algorithm and/or computer hardware setup. For example, an algorithm may be implemented to have the conditional keep generating recursive frames in a loop until the conditional model generates a frame that exceeds some threshold (e.g., the distance of pixels representing the same edge of an object between two frames and/or pixel values between two frames have exceeded a Euclidian distance threshold and/or pixel value change threshold), which indicates artifacts have been introduced. In response to detecting such threshold has been exceeded, some embodiments then call the marginal model to use the marginal model's output instead of the conditional model(s) output, at which point the loop continues for the next frame to have the conditional model keep predicting the next frame if and until detecting such threshold for a particular frame. In other words, in these embodiments, the conditional model always produces the frame(s) if and until a frame introduces an artifact, at which point the marginal model is used to clean the artifact, and the cleaned frame is used in the recursive process. With respect to hardware setup, the conditional and marginal models can be included in the same host computing device. In other embodiments, they can be split up across hosts. For example, the marginal model may be clunky and large (e.g., contains trillions of parameters). In these situations, the conditional model may only call the marginal model every X (e.g., 20) frames, as opposed to every frame.

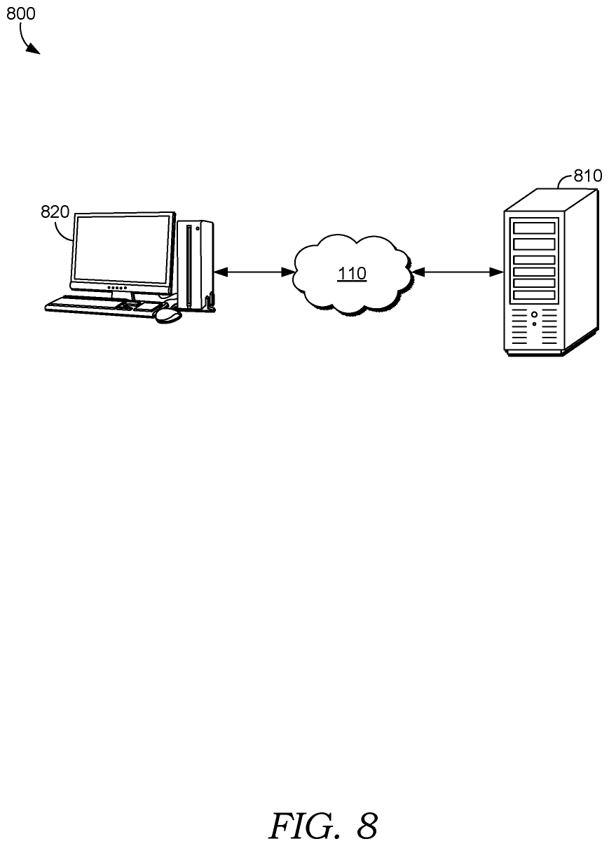

Turning now to FIG. 8, a schematic depiction is provided illustrating an example computing environment 800 for generating recursive frames (e.g., as described with respect to the process 600 of FIG. 6, 700 of FIG. 7, and/or 800 of FIG. 8), in which some embodiments of the present invention may be employed. It should be understood that this and other arrangements described herein are set forth only as examples. Other arrangements and elements (e.g., machines, interfaces, functions, orders, groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. For example, there may be multiple servers 810 that represent nodes in a cloud computing network. Various functions described herein as being performed by one or more entities may be carried out by hardware, firmware, and/or software. For instance, various functions may be carried out by a processor executing instructions stored in memory.

The environment 800 depicted in FIG. 8 includes a prediction server (“server”) 810 that is in communication with the network 110. The environment 800 further includes a client device (“client”) 820 that is also in communication with the network 110. Among other things, the client 820 can communicate with the server 810 via the network 110, and generate for communication, to the server 810, a request to make recursive predictions of frames. For example, an access point and/or television (the client device 820) may request a content server (the server 810) to provide content frame by frame, which is then returned back to the client 820. In various embodiments, the client 820 is embodied in a computing device, which may be referred to herein as a client device or user device, as described with respect to the computing device 9 of FIG. 9.

In some embodiments, each component FIG. 1 is included in the server 810 or the client device 820. Alternatively, in some embodiments, the components in FIG. 1 are distributed between the server 810 and client device 820.

The server 810 can receive the request communicated from the client 820, and can search for relevant data via any number of data repositories to which the server 810 can access, whether remotely or locally. A data repository can include one or more local computing devices or remote computing devices, each accessible to the server 810 directly or indirectly via network 110. In accordance with some embodiments described herein, a data repository can include any of one or more remote servers, any node (e.g., a computing device) in a distributed plurality of nodes, such as those typically maintaining a distributed ledger (e.g., block chain) network, or any remote server that is coupled to or in communication with any node in a distributed plurality of nodes. Any of the aforementioned data repositories can be associated with one of a plurality of data storage entities, which may or may not be associated with one another. As described herein, a data storage entity can include any entity (e.g., retailer, manufacturer, e-commerce platform, social media platform, web host) that stores data (e.g., names, demographic data, purchases, browsing history, location, addresses) associated with its customers, clients, sales, relationships, website visitors, or any other subject to which the entity is interested. It is contemplated that each data repository is generally associated with a different data storage entity, though some data storage entities may be associated with multiple data repositories and some data repositories may be associated with multiple data storage entities. In various embodiments, the server 810 is embodied in a computing device, such as described with respect to the computing device 900 of FIG. 9.

Having described embodiments of the present invention, an exemplary operating environment in which embodiments of the present invention may be implemented is described below in order to provide a general context for various aspects of the present invention. Referring initially to FIG. 9 in particular, an exemplary operating environment for implementing embodiments of the present invention is shown and designated generally as computing device 80. Computing device 80 is but one example of a suitable computing environment and is not intended to suggest any limitation as to the scope of use or functionality of the invention. Neither should the computing device 80 be interpreted as having any dependency or requirement relating to any one or combination of components illustrated.

Looking now to FIG. 9, computing device 80 includes a bus 10 that directly or indirectly couples the following devices: memory 12, one or more processors 14, one or more presentation components 16, input/output (I/O) ports 18, input/output components 20, and an illustrative power supply 22. Bus 10 represents what may be one or more buses (such as an address bus, data bus, or combination thereof). Although the various blocks of FIG. 9 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. The inventor recognizes that such is the nature of the art, and reiterates that the diagram of FIG. 9 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 9 and reference to “computing device.”

Computing device 80 typically includes a variety of computer-readable media. Computer-readable media can be any available media that can be accessed by computing device 80 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 80. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media. In various embodiments, the computing device 80 represents the client device 920 and/or the server 910 of FIG. 9.

Memory 12 includes computer-storage media in the form of volatile and/or nonvolatile memory. The memory may be removable, non-removable, or a combination thereof. Exemplary hardware devices include solid-state memory, hard drives, optical-disc drives, etc. Computing device 80 includes one or more processors 14 (e.g., a GPU and/or CPU) that read data from various entities such as memory 12 or I/O components 20. Presentation component(s) 16 present data indications to a user or other device. Exemplary presentation components include a display device, speaker, printing component, vibrating component, etc. In some embodiments, the memory includes program instructions that, when executed by one or more processors, cause the one or more processors to perform any functionality described herein, such as the process 700 of FIG. 7, the process 800 of FIG. 8, or any functionality described with respect to FIGS. 1 through 9.

I/O ports 18 allow computing device 80 to be logically coupled to other devices including I/O components 20, some of which may be built in. Illustrative components include a microphone, joystick, gamepad, satellite dish, scanner, printer, wireless device, etc. The I/O components 20 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 80. The computing device 80 may be equipped with depth cameras, such as stereoscopic camera systems, infrared camera systems, RGB camera systems, touchscreen technology, and combinations of these, for gesture detection and recognition. Additionally, the computing device 80 may be equipped with accelerometers or gyroscopes that enable detection of motion. The output of the accelerometers or gyroscopes may be provided to the display of the computing device 80 to render immersive augmented reality or virtual reality.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

### EXAMPLE CLAUSES

The following clauses represent example aspects of concepts contemplated herein. Any one of the following clauses may be combined in a multiple dependent manner to depend from one or more other clauses. Further, any combination of dependent clauses (clauses that explicitly depend from a previous clause) may be combined while staying within the scope of aspects contemplated herein. The following clauses are examples and are not limiting.
Clause 1: A system comprising: at least one computer processor; and one or more computer storage media storing computer-useable instructions that, when used by the at least one computer processor, cause the at least one computer processor to perform operations comprising: receiving a first set of one or more frames; providing, as at least a portion of a first input, the first set of one or more frames into a conditional model, wherein the conditional model generates a second set of one or more frames based at least in part on the first input; providing the second set of one or more frames as input into a marginal model, wherein the marginal model generates, via at least a portion of a diffusion process, a third set of one or more frames; and based at least in part on the marginal model generating the third set of one or more frames via at least a portion of the diffusion process, providing, as at least a second portion of a second input, the third set of one or more frames into the conditional model, wherein the conditional model generates a fourth set of one or more frames based at least in part on the first input and the second input.
Clause 2: The system of clause 1, wherein the first, second, third, and fourth set of one or more frames represent one of, one or more digital images, one or more video frames, one or more single interlaced fields, one or more audio signals, or one or more files.
Clause 3: The system of clause 1 and/or 2, wherein the second set of one or more frames represent one or more frames that are predicted to be next in a sequential order after the first set of one or more frames, and wherein the third set of one or more frames represent a cleaned up version of the second set of one or more frames, and wherein the operations further comprising: excluding from providing the second set of one or more frames into the conditional model based at least in part on the generating of the third set of one or more frames, and wherein the fourth set of one or more frames represent at least one frame that is predicted to be next in the sequential order after the third set of one or more frames.
Clause 4: The system of clause 1, 2, and/or 3, wherein the marginal model generates the third set of one or more frames by starting the diffusion process at an intermediate step based at least in part on providing noise as a portion of the input into the marginal model, and wherein the diffusion is indicative of preventing artifacts from propagating over time as the fourth set of one or more images are generated.
Clause 5: The system of clause 1, 2, 3, and/or 4, wherein the conditional model is one of a probabilistic diffusion model or a deterministic prediction model trained on mean squared error (MSE).
Clause 6: The system of clause 1, 2, 3, 4, and/or 5, wherein the conditional model generates the first set of one or more frames by running diffusion only part way through a second diffusion process.
Clause 7: The system of clause 1, 2, 3, 4, 5, and/or 6, wherein at least one of the first input or the second input includes at least one of a natural language text prompt, an audio signal, or a color request, and wherein the generating of the second set of one or more frames or the generating of the third set of one or more frames is based at least in part on at least one of, the natural language text prompt, the audio signal, or a color request.
Clause 8: The system of clause 1, 2, 3, 4, 5, 6, 7, and/or 8, wherein the operations further comprising: receiving user prompt that constrains at least one of the conditional model or the marginal model to generate content until a target final frame is generated, and wherein at least one of, the second set of one or more frames, the third set of one or more frames, or the fourth set of one or more frames includes the target final frame that is generated based at least in part on the user prompt.
Clause 9: The system of clause 1, 2, 3, 4, 5, 6, 7, and/or 8, wherein the third set of one or more frames the generated by the marginal model represents a frame with one or more visual artifacts that have been removed from the second set of one or more frames.
Clause 10: A computer-implemented method comprising: receiving a first set of one or more frames; based at least in part on the first set of one or more frames, generating a second set of one or more frames, the second set of one or more frames represent one or more frames that are predicted to be next in a sequential order after the first set of one or more frames; based at least in part on the second set of one or more frames, generating, via a least a portion of a diffusion process, a third set of one or more frames, the third set of one or more frames represent a different version of the second set of one or more frames; and based at least in part on the third set of one or more frames, generating a fourth set of one or more frames, and wherein the fourth set of one or more frames represent at least one frame that is predicted to be next in the sequential order after the third set of one or more frames.
Clause 11: The computer-implemented method of clause 10, wherein the first, second, third, and fourth set of one or more frames represent one of, one or more digital images, one or more video frames, one or more single interlaced fields, one or more audio signals, or one or more files.
Clause 12: The computer-implemented method of clause 10 and/or 11, wherein the second set of one or more frames and the fourth set of one or more frames are generated by a conditional model, and wherein the third set of one or more frames are generated by a marginal model.
Clause 13: The computer-implemented method of clause 10, 11, and/or 12, wherein the conditional model is one of a probabilistic diffusion model or a deterministic prediction model trained on mean squared error (MSE).
Clause 14: The computer-implemented method of clause 10, 11, 12, and/or 13, wherein the conditional model generates the first set of one or more frames by running diffusion only part way through a second diffusion process.
Clause 15: The computer-implemented method of clause 10, 11, 12, 13, and/or 14, wherein a marginal model generates the third set of one or more frames by starting the diffusion process at an intermediate step based at least in part on providing noise as a portion of the input into the marginal model, and wherein the diffusion is indicative of preventing artifacts from propagating over time as the fourth set of one or more images are generated.
Clause 16: The computer-implemented method of clause 10, 11, 12, 13, 14, and/or 15 wherein the generating of the second set of one or more frames or the third set of one or more frames is further based at least in part on at least one of a natural language text prompt, an audio signal, or a color request.
Clause 17: The computer-implemented method of clause 10, 11, 12, 13, 14, 15, and/or 16, further comprising: receiving user prompt that constrains at least one of a conditional model or a marginal model to generate content until a target final frame is generated, and wherein at least one of, the second set of one or more frames, the third set of one or more frames, or the fourth set of one or more frames includes the target final frame that is generated based at least in part on the user prompt.
Clause 18: The computer-implemented method of clause 10, 11, 12 13 14, 15, 16, and/or 17, wherein the third set of one or more frames represents a frame with one or more visual artifacts that have been removed from the second set of one or more frames.
Clause 19: One or more computer storage media having computer-executable instructions embodied thereon that, when executed, by one or more processors, cause the one or more processors to perform operations comprising: generating, via a conditional model, a second set of one or more frames based at least in part on processing a first set of one or more frames; generating, via a diffusion process and a marginal model, a third set of one or more frames based on using the second set of one or more frames generated via the conditional model as input into the marginal model, wherein the third set of one or more frames representing the second set of one or more frames except that the third set of one or more frames include one or more frame elements that have different values than one or more frame elements of the second set of one or more frames; and based at least in part on the marginal model generating the third set of one or more frames via at least a portion of the diffusion process, generating, via the conditional model, a fourth set of one or more frames based at least in part on using the third set of one or more frames as input instead of the second set of one or more frames.
Clause 20: The one or more computer storage media of clause 19, wherein the third set of one or more frames represents a frame with one or more visual artifacts that have been removed from the second set of one or more frames.
Clause 21: The one or more computer storage media of clause 19, further comprising clauses 1, 2, 3, 4, 5, 6, 7, 8, 9, 10, 11, 12, 13, 14, 15, 16, 17, 18, 19, and/or 20.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

The invention claimed is:

1. A system comprising:
at least one computer processor; and
one or more computer storage media storing computer-useable instructions that, when used by the at least one computer processor, cause the at least one computer processor to perform operations comprising:
receiving a first set of one or more frames;
providing, as at least a portion of a first input, the first set of one or more frames into a conditional model, wherein the conditional model generates a second set of one or more frames based at least in part on the first input;
providing the second set of one or more frames as input into a marginal model, wherein the marginal model generates, via at least a portion of a diffusion process, a third set of one or more frames; and
based at least in part on the marginal model generating the third set of one or more frames via at least a portion of the diffusion process, providing, as at least a second portion of a second input, the third set of one or more frames into the conditional model, wherein the conditional model generates a fourth set of one or more frames based at least in part on the first input and the second input.

2. The system of claim 1, wherein the first, second, third, and fourth set of one or more frames represent one of, one or more digital images, one or more video frames, one or more single interlaced fields, one or more audio signals, or one or more files.

3. The system of claim 1, wherein the second set of one or more frames represent one or more frames that are predicted to be next in a sequential order after the first set of one or more frames, and wherein the third set of one or more frames represent a cleaned up version of the second set of one or more frames, and wherein the operations further comprising:
excluding from providing the second set of one or more frames into the conditional model based at least in part on the generating of the third set of one or more frames, and wherein the fourth set of one or more frames represent at least one frame that is predicted to be next in the sequential order after the third set of one or more frames.

4. The system of claim 1, wherein the marginal model generates the third set of one or more frames by starting the diffusion process at an intermediate step based at least in part on providing noise as a portion of the input into the marginal model, and wherein the diffusion is indicative of preventing artifacts from propagating over time as the fourth set of one or more images are generated.

5. The system of claim 1, wherein the conditional model is one of a probabilistic diffusion model or a deterministic prediction model trained on mean squared error (MSE).

6. The system of claim 1, wherein the conditional model generates the first set of one or more frames by running diffusion only part way through a second diffusion process.

7. The system of claim 1, wherein at least one of the first input or the second input includes at least one of a natural language text prompt, an audio signal, or a color request, and wherein the generating of the second set of one or more frames or the generating of the third set of one or more frames is based at least in part on at least one of, the natural language text prompt, the audio signal, or a color request.

8. The system of claim 1, wherein the operations further comprising:
receiving user prompt that constrains at least one of the conditional model or the marginal model to generate content until a target final frame is generated, and wherein at least one of, the second set of one or more frames, the third set of one or more frames, or the fourth set of one or more frames includes the target final frame that is generated based at least in part on the user prompt.

9. The system of claim 1, wherein the third set of one or more frames the generated by the marginal model represents a frame with one or more visual artifacts that have been removed from the second set of one or more frames.

10. A computer-implemented method comprising:
receiving a first set of one or more frames;
based at least in part on the first set of one or more frames, generating a second set of one or more frames, the second set of one or more frames represent one or more frames that are predicted to be next in a sequential order after the first set of one or more frames;
based at least in part on the second set of one or more frames, generating,
via a least a portion of a diffusion process, a third set of one or more frames, the third set of one or more frames represent a different version of the second set of one or more frames; and
based at least in part on the third set of one or more frames, generating a fourth set of one or more frames, and wherein the fourth set of one or more frames represent at least one frame that is predicted to be next in the sequential order after the third set of one or more frames.

11. The computer-implemented method of claim 10, wherein the first, second, third, and fourth set of one or more frames represent one of, one or more digital images, one or more video frames, one or more single interlaced fields, one or more audio signals, or one or more files.

12. The computer-implemented method of claim 10, wherein the second set of one or more frames and the fourth set of one or more frames are generated by a conditional model, and wherein the third set of one or more frames are generated by a marginal model.

13. The computer-implemented method of claim 12, wherein the conditional model is one of a probabilistic diffusion model or a deterministic prediction model trained on mean squared error (MSE).

14. The computer-implemented method of claim 12, wherein the conditional model generates the first set of one or more frames by running diffusion only part way through a second diffusion process.

15. The computer-implemented method of claim 10, wherein a marginal model generates the third set of one or more frames by starting the diffusion process at an intermediate step based at least in part on providing noise as a portion of the input into the marginal model, and wherein the diffusion is indicative of preventing artifacts from propagating over time as the fourth set of one or more images are generated.

16. The computer-implemented method of claim 10, wherein the generating of the second set of one or more frames or the third set of one or more frames is further based at least in part on at least one of a natural language text prompt, an audio signal, or a color request.

17. The computer-implemented method of claim 10, further comprising:
receiving user prompt that constrains at least one of a conditional model or a marginal model to generate content until a target final frame is generated, and wherein at least one of, the second set of one or more frames, the third set of one or more frames, or the fourth set of one or more frames includes the target final frame that is generated based at least in part on the user prompt.

18. The computer-implemented method of claim 10, wherein the third set of one or more frames represents a frame with one or more visual artifacts that have been removed from the second set of one or more frames.

19. One or more computer storage media having computer-executable instructions embodied thereon that, when executed, by one or more processors, cause the one or more processors to perform operations comprising:
generating, via a conditional model, a second set of one or more frames based at least in part on processing a first set of one or more frames;
generating, via a diffusion process and a marginal model, a third set of one or more frames based on using the second set of one or more frames generated via the conditional model as input into the marginal model, wherein the third set of one or more frames representing the second set of one or more frames except that the third set of one or more frames include one or more frame elements that have different values than one or more frame elements of the second set of one or more frames; and
based at least in part on the marginal model generating the third set of one or more frames via at least a portion of the diffusion process, generating, via the conditional model, a fourth set of one or more frames based at least in part on using the third set of one or more frames as input instead of the second set of one or more frames.

20. The one or more computer storage media of claim 19, wherein the third set of one or more frames represents a frame with one or more visual artifacts that have been removed from the second set of one or more frames.
